(19) United States
(12) Patent Application Publication
(10) Pub. No.: US 2025/0093760 A1
(43) Pub. Date: Mar. 20, 2025

(54) PROJECTION LENS AND PROJECTION DEVICE

(71) Applicant: Coretronic Corporation, Hsin-Chu (TW)

(72) Inventors: Wen-Chun Wang, Hsin-Chu (TW); Wei-Ting Wu, Hsin-Chu (TW); You-Da Chen, Hsin-Chu (TW); Ching-Chuan Wei, Hsin-Chu (TW)

(73) Assignee: Coretronic Corporation, Hsin-Chu (TW)

(21) Appl. No.: 18/824,924

(22) Filed: Sep. 5, 2024

(30) Foreign Application Priority Data
Sep. 14, 2023 (CN) 202311183193.4

(51) Int. Cl. G03B 21/28; G02B 13/16

(52) U.S. Cl. CPC G03B 21/28; G02B 13/16

(57) ABSTRACT

A projection lens includes a first and a second optical lens assembly. The first optical lens assembly is configured to transmit an image beam to the second optical lens assembly, which projects out the image beam from the projection lens. The second optical lens assembly includes a first and a second reflective element, and an optical member disposed between the first and the second reflective element and including a translucent region and a reflective region. The first reflective element is configured to reflect the image beam from the first optical lens assembly and transmit to the translucent region, which allows the image beam from the first reflective element to pass through and transmit to the second reflective element. The second reflective element is configured to reflect the image beam from the translucent region and transmit to the reflective region, which reflects the image beam from the second reflective element.

### CROSS-REFERENCE TO RELATED APPLICATION

This application claims the priority benefit of China application serial no. 202311183193.4, filed on Sep. 14, 2023. The entirety of the above-mentioned patent application is hereby incorporated by reference herein and made a part of this specification.

### BACKGROUND

### Technical Field

The disclosure relates to an optical lens and an electronic device, and in particular to a projection lens and a projection device.

### Description of Related Art

The current trend of projectors is to develop high-brightness and large-size projection screens. Therefore, various manufacturers are focusing on designing a suitable wide-angle lens structure to reduce the weight and size whilst effectively reducing the production cost. Due to the various considerations, most wide-angle lens designs are dominated by fixed-focus lenses. Generally speaking, in order to reduce the size of the lens element of the wide-angle lens, an intermediate image is usually formed in the design of the optical path to reduce the overall optical path, which can further reduce the outer diameter of the entire lens. The overall length of an optical system which forms the intermediate image is longer than the overall length of an optical system designed without the intermediate image.

However, in the current technology, the overall number of lens elements in the lens is many, resulting in no advantage in price and market competition. In addition, if the length of the lens is designed long, it is likely to affect the size of the projector. Therefore, designing lenses that can reduce the production cost and shorten the time for assembly process is what we need to work on in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a projection lens and a projection device that can fold the optical path to reduce the size of the projection lens and simplify the difficulty in manufacturing the projection lens while maintaining a good optical quality.

Other objects and advantages of the disclosure can be further understood from the technical features disclosed in the disclosure.

In order to achieve one, part of, or all of the above purposes or other purposes, the disclosure provides a projection lens including a first optical lens assembly and a second optical lens assembly. The first optical lens assembly is configured to transmit an image beam to the second optical lens assembly. The second optical lens assembly is configured to project out the image beam from the projection lens. The second optical lens assembly includes a first reflective element, a second reflective element, and an optical member. The optical member is disposed between the first reflective element and the second reflective element. The optical member includes a translucent region and a reflective region. The first reflective element is configured to reflect the image beam from the first optical lens assembly and transmit to the translucent region. The translucent region is configured to allow the image beam from the first reflective element to pass through and transmit to the second reflective element. The second reflective element is configured to reflect the image beam from the translucent region and transmit to the reflective region. The reflective region is configured to reflect the image beam from the second reflective element.

In order to achieve one, part of, or all of the above purposes or other purposes, the disclosure further provides a projection device including an illumination system, at least one light valve, and a projection lens. The illumination system is configured to provide an illumination beam. The at least one light valve is disposed on a transmission path of the illumination beam to convert the illumination beam into an image beam. The projection lens is disposed on a transmission path of the image beam. The projection lens includes a first optical lens assembly and a second optical lens assembly. The first optical lens assembly is configured to transmit the image beam to the second optical lens assembly. The second optical lens assembly is configured to project out the image beam from the projection lens. The second optical lens assembly includes a first reflective element, a second reflective element, and an optical member. The optical member is disposed between the first reflective element and the second reflective element. The optical member includes a translucent region and a reflective region. The first reflective element is configured to reflect the image beam from the first optical lens assembly and transmit to the translucent region. The translucent region is configured to allow the image beam from the first reflective element to pass through and transmit to the second reflective element. The second reflective element is configured to reflect the image beam from the translucent region and transmit to the reflective region. The reflective region is configured to reflect the image beam from the second reflective element.

Based on the above, the embodiments according to the disclosure has at least one of the following advantages or effects. In the projection lens and the projection device according to the disclosure, the projection lens includes the first optical lens assembly and the second optical lens assembly, the second optical lens assembly includes the first reflective element, the second reflective element, and the optical member, and the optical member includes the translucent region and the reflective region. The translucent region is configured to allow the image beam from the first reflective element to pass through and transmit to the second reflective element, and the reflective region is configured to reflect the image beam from the second reflective element. Therefore, when the image beam is transmitted from the first optical lens assembly to the second optical lens assembly, the image beam is transmitted to the first reflective element to generate a first reflection, is transmitted and passes through the translucent region to be transmitted to the second reflective element to generate a second reflection, and is transmitted to the reflective region to generate a third reflection. In this way, the optical path can be folded to reduce the size of the projection lens and simplify the difficulty in manufacturing the projection lens while maintaining a good optical quality. In addition, when the image beam passes through the translucent region, the distortion aberration can be effectively reduced, the distance between the first reflective element and the second reflective element can be reduced, the optical resolution can be improved, and the effective diameter of the second reflective element can be reduced.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the disclosure.

FIG. 2 is a schematic diagram of a projection lens according to an embodiment of the disclosure.

FIG. 3 is a diagram of a modulation transfer function of the projection lens in FIG. 2.

FIG. 4A and FIG. 4B are respectively diagrams of field curvature aberrations in different directions of the projection lens in FIG. 2.

FIG. 5 is a diagram of a distortion aberration of the projection lens in FIG. 2.

FIG. 6A to FIG. 6V are ray fan plots of the projection lens in FIG. 2.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

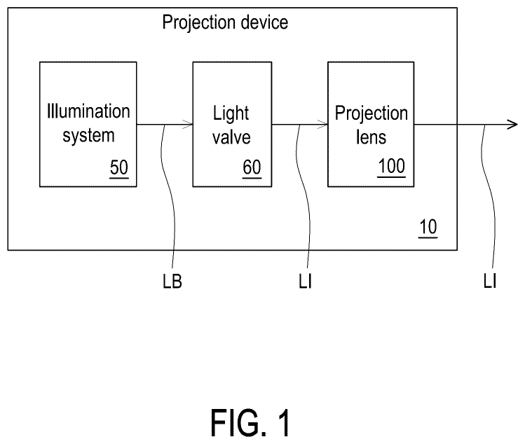

FIG. 1 is a schematic diagram of a projection device according to an embodiment of the disclosure. Please refer to FIG. 1. The embodiment provides a projection device 10, which includes an illumination system 50, at least one light valve 60, and a projection lens 100. The illumination system 50 is configured to provide an illumination beam LB. The at least one light valve 60 is disposed on a transmission path of the illumination beam LB to convert the illumination beam LB into an image beam LI. The projection lens 100 is disposed on a transmission path of the image beam LI and is configured to project out the image beam LI from the projection device 10 to a projection target (not shown), such as a screen or a wall.

The illumination system 50 is configured to provide the illumination beam LB. For example, in this embodiment, the illumination system 50 comprises multiple light emitting elements, wavelength conversion elements, light uniforming elements, filter elements, and multiple light splitting and converging elements to provide lights of different wavelengths to form the illumination beam LB. The multiple light emitting elements are, for example, light emitting diodes (LED) or laser diodes (LD). However, the disclosure does not limit the type or form of the illumination system 50 in the projection device 10. The detailed structure and implementation can be referred to the common knowledge in the technical field to obtain sufficient teachings, suggestions, and implementation instructions, so will not be repeated here.

The light valve 60 is, for example, a reflective light modulator such as a liquid crystal on silicon panel (LCoS panel) or a digital micro-mirror device (DMD). In some embodiments, the light valve 60 may also be a transmissive light modulator such as a transparent liquid crystal panel, an electro-optical modulator, a magneto-optic modulator, an acousto-optic modulator (AOM). The disclosure does not limit the type or form of the light valve 60. Regarding the method of the light valve 60 converting the illumination beam LB into the image beam LI, the detailed operations and implementations can be referred to the common knowledge in the technical field to obtain sufficient teachings, suggestions, and implementation instructions, so will not be repeated here. In different embodiments, the number of the light valves 60 may be designed to be one to three, and the disclosure is not limited thereto.

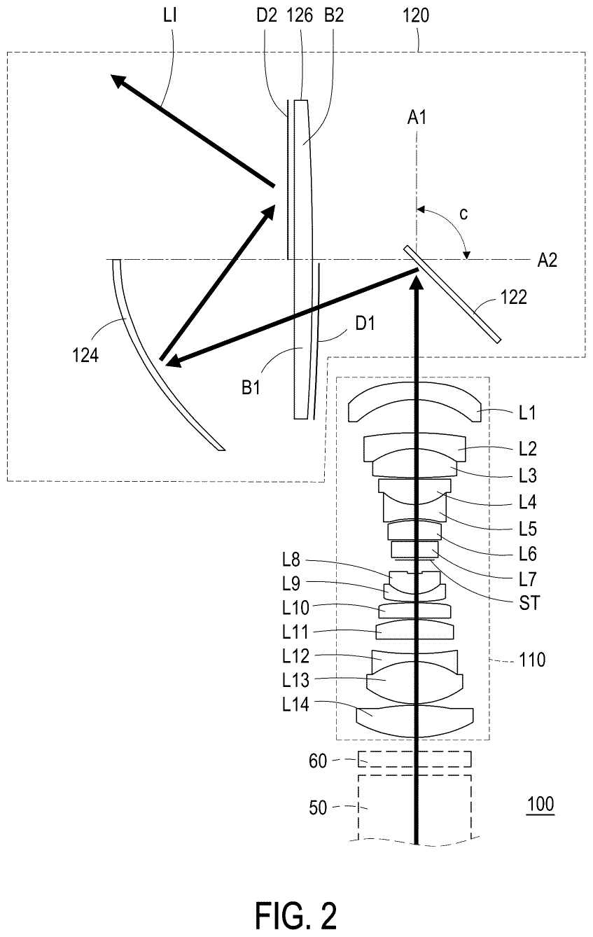

FIG. 2 is a schematic diagram of a projection lens according to an embodiment of the disclosure. The projection lens 100 shown in this embodiment can at least be applied to the projection lens 100 shown in FIG. 1. Therefore, the description below is used as an example. Please refer to FIG. 1 and FIG. 2. The projection lens 100 includes a first optical lens assembly 110 and a second optical lens assembly 120. The first optical lens assembly 110 is configured to transmit the image beam LI to the second optical lens assembly 120, and the second optical lens assembly 120 is configured to project out the image beam LI from the projection lens 100.

The first optical lens assembly 110 includes, for example, a combination of one or more optical lens elements having a diopter, for example, various combinations of non-planar lens elements such as biconcave lens, biconvex lens, concave and convex lens, convex and concave lens, plano-convex lens, and plano-concave lens. The disclosure does not limit the type or form of the first optical lens assembly 110. For example, in the embodiment, the first optical lens assembly 110 includes, sequentially from an image side to an object side along an optical axis A1, a first lens element L1, a second lens element L2, a third lens element L3, a fourth lens element L4, a fifth lens element L5, a sixth lens element L6, a seventh lens element L7, an aperture ST, an eighth lens element L8, a ninth lens element L9, a tenth lens element L10, an eleventh lens element L11, a twelfth lens element L12, a thirteenth lens element L13, and a fourteenth lens element L14.

The second optical lens assembly 120 includes a first reflective element 122, a second reflective element 124, and an optical member 126. The optical member 126 is disposed between the first reflective element 122 and the second reflective element 124. The optical member 126 includes a translucent region B1 and a reflective region B2. The translucent region B1 is positioned between the reflective region B2 and the first optical lens assembly 110. The first reflective element 122 is configured to reflect the image beam LI from the first optical lens assembly 110 and transmit to the translucent region B1. In this embodiment, the first reflective element 122 is, for example, a planar lens, but in other embodiments, the first reflective element 122 may also be a concave lens, and the disclosure is not limited thereto. The second reflective element 124 is configured to reflect the image beam LI from the translucent region B1 of the optical member 126 and transmit to the reflective region B2. In this embodiment, the second reflective element 124 is, for example, a concave lens, but the disclosure is not limited thereto.

The translucent region B1 of the optical member 126 is configured to allow the image beam LI from the first reflective element 122 to pass through and transmit to the second reflective element 124, and the reflective region B2 is configured to reflect the image beam LI from the second reflective element 124. In other words, the optical member 126 has two regions with different optical effects. For example, in the embodiment, the optical member 126 has an optical axis A2, a dividing line between the translucent region B1 and the reflective region B2 is positioned on the optical axis A2, and the optical axis A1 of the first optical lens assembly 110 and the optical axis A2 of the optical member 126 have an included angle C, for example, 90 degrees. That is, the optical axis A1 of the first optical lens assembly 110 is perpendicular to the optical axis A2 of the optical member 126. However, the disclosure is not limited thereto. Specifically, the optical member 126 is an optical lens element having a diopter, for example, various combinations of non-planar lens elements such as biconcave lens, biconvex lens, concave and convex lens, convex and concave lens, plano-convex lens, and plano-concave lens, and a surface thereof is, for example, spherical or aspheric. Therefore, when the image beam LI passes through the translucent region B1, the distortion aberration can be effectively reduced, the distance between the first reflective element 122 and the second reflective element 124 can be reduced, the optical resolution can be improved, and the effective diameter of the second reflective element 124 can be reduced. In this embodiment, the optical member 126 includes an antireflective coating D1 and a reflective coating D2. The antireflective coating D1 is disposed in the translucent region B1, and the reflective coating D2 is disposed in the reflective region B2. In an embodiment, the translucent region B1 of the optical member 126 may not have the antireflective coating D1, and merely the reflective region B2 is disposed with the reflective coating D2. Therefore, when the image beam LI is transmitted from the first optical lens assembly 110 to the second optical lens assembly 120, the image beam LI is transmitted to the first reflective element 122 to generate a first reflection, is transmitted and passes through the translucent region B1 to be transmitted to the second reflective element 124 to generate a second reflection, and is transmitted to the reflective region B2 to generate a third reflection. In this way, the optical path can be folded to reduce the size of the projection lens 100 and simplify the difficulty in manufacturing the projection lens 100 while maintaining a good optical quality.

In this embodiment, the actual design of each element of the first optical lens assembly 110 and the second optical lens assembly 120 may be seen in Table 1 below. In Table 1, from the image side to the object side, the reflective region B2 to the fourteenth lens element L14 have a surface R1 and a surface R2, or merely have the surface R1, and “distance” refers to the linear distance between the surface and the next adjacent surface on the optical axis A1 or the optical axis A2. For example, the distance of the surface R1 of the first lens element L1 refers to the distance between the surface R1 of the first lens element L1 and the surface R2 of the first lens element L1 on the optical axis A1, and the distance of the surface R2 of the first lens element L1 refers to the linear distance between the surface R2 of the first lens element L1 and the surface R1 of the second lens element L2 on the optical axis A1, and so on.

TABLE I

| | | Curvature | | Refractive | |
|---|---|---|---|---|---|
| | | radius | Distance | index | Abbe |
| Element | Surface | (mm) | (mm) | (Nd) | number(Vd) |
| B2 | | Infinite | −23.000 | | |
| 124 | | 0.045 | 23.000 | 1.57 | 62.6 |
| B1 | R1 | Infinite | 2.475 | 1.57 | 62.6 |
| | R2 | −0.003 | 13.500 | | |
| 122 | | Infinite | −16.195 | Glass | |
| L1 | R1 | −0.030 | −2.263 | 1.52 | 56.3 |
| | R2 | −0.101 | −4.425 | | |
| L2 | R1 | −0.029 | −2.085 | 1.92 | 18.9 |
| L3 | R1 | −0.107 | −3.818 | 1.68 | 29.2 |
| | R2 | 0.017 | −0.200 | | |
| L4 | R1 | −0.004 | −3.454 | 1.65 | 36.5 |
| L5 | R1 | 0.160 | −1.848 | 1.84 | 33.7 |
| | R2 | −0.055 | −0.200 | | |
| L6 | R1 | −0.090 | −2.564 | 1.79 | 22.0 |
| | R2 | 0.015 | −0.200 | | |
| L7 | R1 | −0.008 | −2.109 | 1.76 | 43.0 |
| | R2 | 0.024 | −0.259 | | |
| ST | | Infinite | −1.691 | | |
| L8 | R1 | 0.047 | −2.800 | 1.58 | 37.8 |
| L9 | R1 | 0.194 | −1.000 | 1.85 | 32.9 |
| | R2 | 0.027 | −0.200 | | |
| L10 | R1 | −0.033 | −2.049 | 1.87 | 19.9 |
| | R2 | −0.006 | −0.200 | | |
| L11 | R1 | −0.062 | −2.549 | 1.92 | 20.9 |
| | R2 | −0.004 | −1.937 | | |
| L12 | R1 | 0.028 | −1.000 | 1.90 | 22.5 |
| L13 | R1 | −0.107 | −5.610 | 1.50 | 81.6 |
| | R2 | 0.090 | −0.200 | | |
| L14 | R1 | −0.044 | −4.197 | 1.58 | 59.0 |
| | R2 | 0.042 | −2.000 | | |

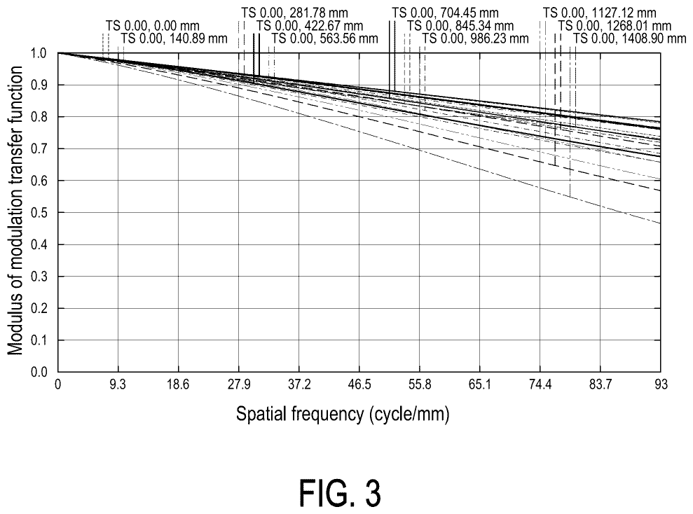

FIG. 3 is a diagram of a modulation transfer function of the projection lens in FIG. 2. Please refer to FIG. 3. In this embodiment, the second reflective element 124, the surface R1 of the first lens element L1, the surface R2 of the first lens element L1, the surface R1 of the seventh lens element L7, the surface R2 of the seventh lens element L7, the surface R1 of the fourteenth lens element L14, and the surface R2 of the fourteenth lens element L14 are aspheric, and the surfaces of the other lens elements are all spherical. The formula of aspheric surfaces can be as follows:

$$X = \frac{{c}^{′} {y}^{2}}{1 + \sqrt{1 - ( 1 + K ) {{c}^{′}}^{2} {y}^{2}}} + {Ay}^{2} + {Ay}^{4} + {By}^{6} + {Cy}^{8} + {Dy}^{10} + {Ey}^{12} + {Fy}^{14} + {Gy}^{16}$$

In the above formula, X is the sag of the optical axis direction. c′ is the reciprocal of the radius of the osculating sphere, which is the reciprocal of the radius of the curve close to the optical axis, K is a quadratic surface coefficient, y is an aspheric height, which is the height from the center of the lens element to the edge of the lens element. A to G represent an aspheric coefficient of each order of the aspheric polynomial. Table 2 lists the parameter values of the aspheric surfaces in the embodiment.

TABLE II

| | 124 | L1R1 | L1R2 |
|---|---|---|---|
| Conic | −8.00E−01 | 0.00E+00 | 0.00E+00 |
| 4th | −6.36E−06 | −3.90E−04 | −2.12E−05 |
| 6th | 5.35E−09 | 1.17E−05 | 2.53E−05 |
| 8th | −1.86E−12 | −4.93E−07 | −1.60E−06 |
| 10th | −1.29E−16 | 1.15E−08 | 5.73E−08 |
| 12th | −1.75E−18 | −1.53E+00 | −1.15E−09 |
| 14th | 1.67E−21 | 1.03E+00 | 1.20E−11 |
| 16th | — | −2.70E−15 | −5.01E−14 |

| | L7R1 | L7R2 | L14R1 | L14R2 |
|---|---|---|---|---|
| Conic | 0.00E+00 | 0.00E+00 | 0.00E+00 | 0.00E+00 |
| 4th | 2.10E−04 | 2.56E−04 | 1.72E−04 | 8.12E−05 |
| 6th | −2.50E−06 | 3.72E−06 | 2.40E−06 | 2.59E−06 |
| 8th | 9.32E−07 | −3.17E−09 | −3.87E+00 | −6.29E−08 |
| 10th | −1.08E−07 | −6.22E−09 | 5.76E−10 | 1.51E−09 |
| 12th | 4.89E−09 | 4.84E−10 | 7.51E−12 | −1.33E−11 |
| 14th | — | — | −1.40E−13 | 5.00E−14 |
| 16th | — | — | — | — |

FIG. 3 is a diagram of a modulation transfer function of the projection lens in FIG. 2. Please refer to FIG. 3. FIG. 3 is a diagram of a modulation transfer function (MTF) of the projection lens 100 at different image heights, in which the horizontal axis is the focus shift, the vertical axis is the modulus of the optical transfer function, t represents the curve in the tangential direction, S represents the curve in the sagittal direction, and the value marked next to “TS” represents the image height. It can be verified that the curve of the optical transfer function shown by the projection lens 100 of this embodiment is within the standard range, so it has a good optical imaging quality, as shown in FIG. 3.

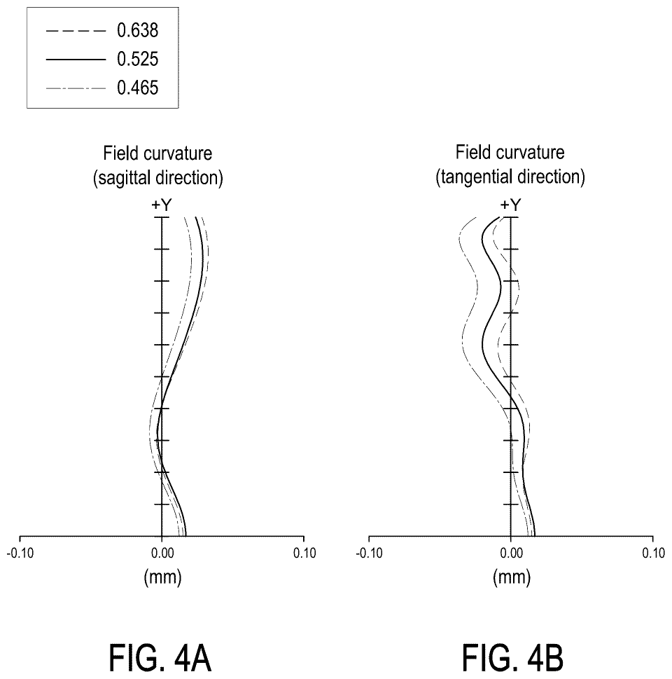

FIG. 4A and FIG. 4B are respectively diagrams of field curvature aberrations in different directions of the projection lens in FIG. 2. Please refer to FIG. 4A and FIG. 4B. The diagrams of FIG. 4A and FIG. 4B respectively illustrate the field curvature aberration in the tangential direction and the field curvature aberration in the sagittal direction on the imaging surface of the embodiment in FIG. 2 when the wavelength is 0.465 μm, 0.525 μm, and 0.638 μm, and the focal length variations of the three representative wavelengths within the entire field of view fall within a range of ±0.05 mm, indicating that the optical system of this embodiment can effectively eliminate aberration.

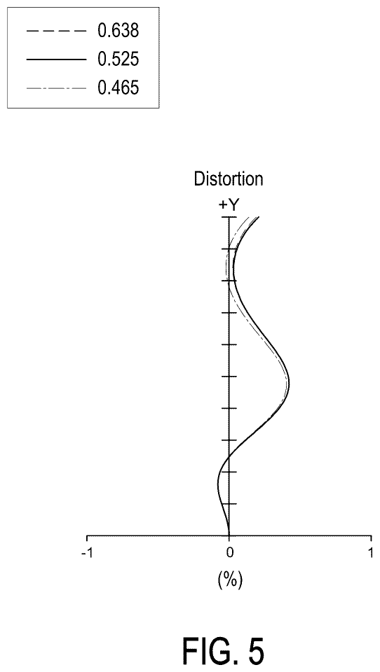

FIG. 5 is a diagram of a distortion aberration of the projection lens in FIG. 2. Please refer to FIG. 5. The diagram of FIG. 5 illustrates the distortion aberration on the imaging surface of the embodiment in FIG. 2 when the wavelength is 0.465 μm, 0.525 μm, and 0.638 μm, and the distortion aberration diagram in FIG. 5 shows that the distortion aberration of the embodiment can be maintained within a range of ±0.5%, indicating that the distortion aberration of this embodiment has complied with the imaging quality requirements of the optical system.

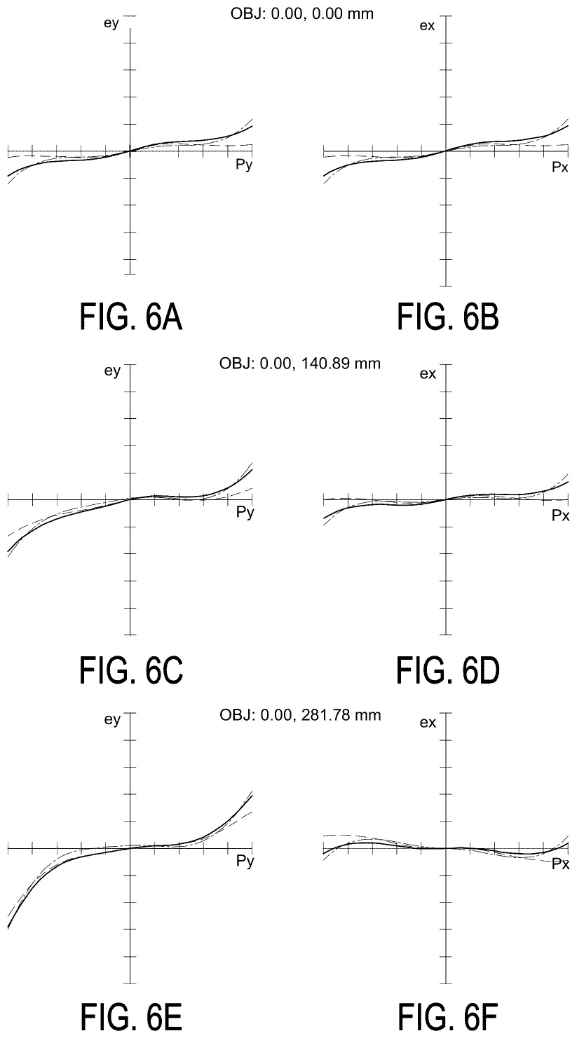

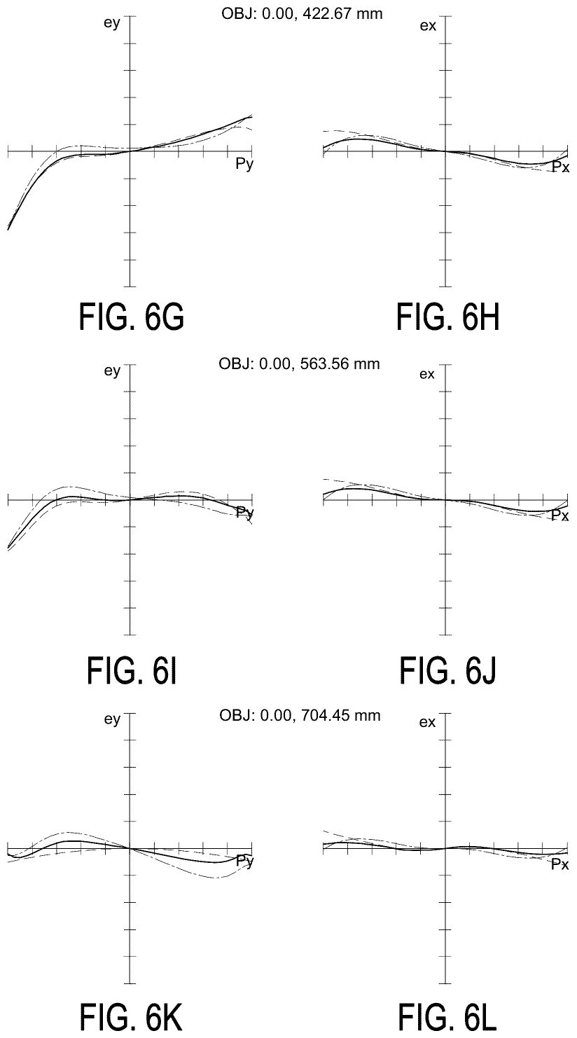

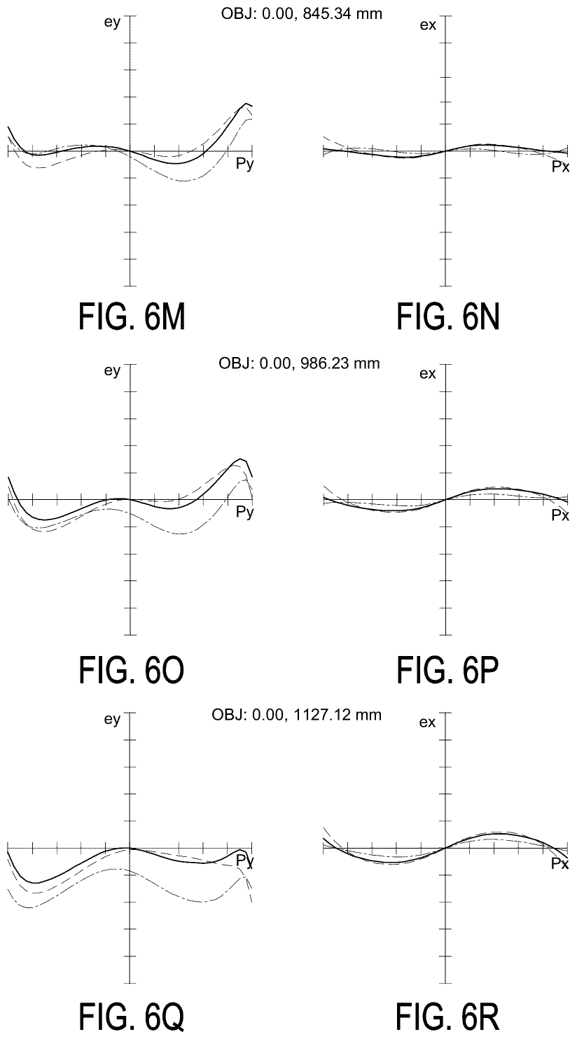

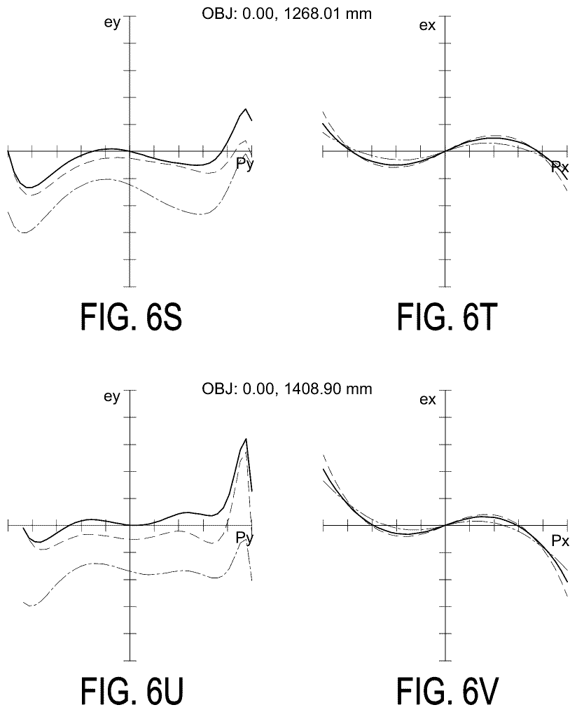

FIG. 6A to FIG. 6V are ray fan plots of the projection lens in FIG. 2. Please refer to FIG. 6A to FIG. 6V. FIG. 6A to FIG. 6V are ray fan plots of the projection lens 100 at different image heights, in which the maximum scales and the minimum scales of the ex, ey, Px, and Py axes are 10 μm and −10 μm respectively. The graphics shown in FIG. 6A to FIG. 6V are all within the standard range, which can verify that the projection lens 100 of the embodiment can achieve a good optical imaging quality.

In summary, in the projection lens and the projection device according to the disclosure, the projection lens includes the first optical lens assembly and the second optical lens assembly, the second optical lens assembly includes the first reflective element, the second reflective element, and the optical member, and the optical member includes the translucent region and reflective region. The translucent region is configured to allow the image beam from the first reflective element to pass through and transmit to the second reflective element, and the reflective region is configured to reflect the image beam from the second reflective element. Therefore, when the image beam is transmitted from the first optical lens assembly to the second optical lens assembly, the image beam is transmitted to the first reflective element to generate the first reflection, is transmitted and passes through the translucent region to be transmitted to the second reflective element to generate the second reflection, and is transmitted to the reflective region to generate the third reflection. In this way, the optical path can be folded to reduce the size of the projection lens and simplify the difficulty in manufacturing the projection lens while maintaining a good optical quality. In addition, when the image beam passes through the translucent region, the distortion aberration can be effectively reduced, the distance between the first reflective element and the second reflective element can be reduced, the optical resolution can be improved, and the effective diameter of the second reflective element can be reduced.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be configured to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A projection lens comprising a first optical lens assembly and a second optical lens assembly, wherein
the first optical lens assembly is configured to transmit an image beam to the second optical lens assembly; and
the second optical lens assembly is configured to project out the image beam from the projection lens, the second optical lens assembly comprises a first reflective element, a second reflective element, and an optical member, the optical member is disposed between the first reflective element and the second reflective element, and the optical member comprises a translucent region and a reflective region, wherein
the first reflective element is configured to reflect the image beam from the first optical lens assembly and transmit to the translucent region;
the translucent region is configured to allow the image beam from the first reflective element to pass through and transmit to the second reflective element;
the second reflective element is configured to reflect the image beam from the translucent region and transmit to the reflective region; and
the reflective region is configured to reflect the image beam from the second reflective element.

2. The projection lens as claimed in claim 1, wherein the optical member has an optical axis, and a dividing line between the translucent region and the reflective region is positioned on the optical axis.

3. The projection lens as claimed in claim 2, wherein the first optical lens assembly has an optical axis, and the optical axis of the first optical lens assembly and the optical axis of the optical member have an included angle.

4. The projection lens as claimed in claim 1, wherein the translucent region is positioned between the reflective region and the first optical lens assembly.

5. The projection lens as claimed in claim 1, wherein the optical member comprises a reflective coating, and the reflective coating is disposed in the reflective region.

6. The projection lens as claimed in claim 1, wherein the optical member comprises an antireflective coating, and the antireflective coating is disposed in the translucent region.

7. The projection lens as claimed in claim 1, wherein the optical member is an optical lens element having a diopter.

8. The projection lens as claimed in claim 1, wherein a surface of the optical member is spherical or aspheric.

9. The projection lens as claimed in claim 1, wherein the first reflective element is a planar lens or a concave lens.

10. The projection lens as claimed in claim 1, wherein the second reflective element is a concave lens.

11. A projection device comprising an illumination system, at least one light valve, and a projection lens, wherein
the illumination system is configured to provide an illumination beam;
the at least one light valve is disposed on a transmission path of the illumination beam to convert the illumination beam into an image beam; and
the projection lens is disposed on a transmission path of the image beam, and the projection lens comprises a first optical lens assembly and a second optical lens assembly, wherein
the first optical lens assembly is configured to transmit the image beam to the second optical lens assembly; and
the second optical lens assembly is configured to project out the image beam from the projection lens, the second optical lens assembly comprises a first reflective element, a second reflective element, and an optical member, the optical member is disposed between the first reflective element and the second reflective element, and the optical member comprises a translucent region and a reflective region, wherein
the first reflective element is configured to reflect the image beam from the first optical lens assembly and transmit to the translucent region;
the translucent region is configured to allow the image beam from the first reflective element to pass through and transmit to the second reflective element;
the second reflective element is configured to reflect the image beam from the translucent region and transmit to the reflective region; and
the reflective region is configured to reflect the image beam from the second reflective element.

12. The projection device as claimed in claim 11, wherein the optical member has an optical axis, and a dividing line between the translucent region and the reflective region is positioned on the optical axis.

13. The projection device as claimed in claim 12, wherein the first optical lens assembly has an optical axis, and the optical axis of the first optical lens assembly and the optical axis of the optical member have an included angle.

14. The projection device as claimed in claim 11, wherein the translucent region is positioned between the reflective region and the first optical lens assembly.

15. The projection device as claimed in claim 11, wherein the optical member comprises a reflective coating, and the reflective coating is disposed in the reflective region.

16. The projection device as claimed in claim 11, wherein the optical member comprises antireflective coating, and the antireflective coating is disposed in the translucent region.

17. The projection device as claimed in claim 11, wherein the optical member is an optical lens element having a diopter.

18. The projection device as claimed in claim 11, wherein a surface of the optical member is spherical or aspheric.

19. The projection device as claimed in claim 11, wherein the first reflective element is a planar lens or a concave lens.

20. The projection device as claimed in claim 11, wherein the second reflective element is a concave lens.
